(19) United States
(12) Patent Application Publication
(10) Pub. No.: US 2025/0226456 A1
(43) Pub. Date: Jul. 10, 2025

(54) Aluminum-Air Fuel Cell Using Bioplastic Electrolyte

(71) Applicant: Olurinde Lafe, Bentleyville, OH (US)

(72) Inventor: Olurinde Lafe, Bentleyville, OH (US)

(73) Assignee: Fuel Cells Global LTD, Bentleyville, OH (US)

(21) Appl. No.: 18/406,095

(22) Filed: Jan. 6, 2024

(51) Int. Cl. H01M 10/26; H01M 4/38; H01M 4/86; H01M 12/06

(52) U.S. Cl. CPC H01M 10/26; H01M 4/38; H01M 4/8626; H01M 12/06; H01M 2300/0005

(57) ABSTRACT

A method and apparatus for generating electricity using an electrochemical cell with a thin aluminum wire as the anode, oxygen extracted from ambient air as the cathode, and a bioplastic electrolyte. The invention teaches the use of inexpensive materials and simplified fuel cell construction and assembling of cells into modules, and modules into ultra-low-cost electricity generators.

### REFERENCES

Bockstie, L., Trevethan, D. & Zaromb, S., 1963. Control of Al corrosion in caustic solutions. Journal of The Electrochemical Society, 110 (4), pp. 267-271.
Du Yuan, Jin Zhao, William Manalastas Jr., Sonal Kumar, Madhavi Srinivasan, 2020. Emerging rechageable aqueous aluminum ion battery: Status, challenges, and outlooks. Nano Materials Science, pp. 248-263.
Friesen, C. A. & Martinez, J. A. B., 2018. s.l. U.S. Pat. No. 10,090,520.
Friesen, C. A., McDowell, F. & Bautista, M. J. A., 2016. Aluminum-Based Metal-Air Batteries. United States of America, U.S. Pat. No. 9,236,643 B2.
Giuseppe, Antonio Elia, Kostiantyn V. Kravchyk, Maksym V. Kovalenko, Joaquin Chacon, Alex Holland, Richard G. A. Wills, 2021. An overview and prospective on Al and Al-ion battery technologies. Journal of Power Resources.
Miller, Y., Tzidon, D. & Yadgar, A., 2021. United States of America, US20210075078.
Mori, R., 2020. Recent Developments for Aluminum-Air Batteries. Electrochemical Energy Reviews, Volume 3, pp. 344-369.
Niksa, M. J., Niksa, A. J. & Noscal, J. M., 1990. Primary aluminum-air battery. United States of America, U.S. Pat. No. 492,5744.
Sasaki, K., 2015. United States of America, US20150009365.
Wang, Y. et al., 2023. Solid-state Al-air battery with an ethanol gel electrolyte. Green Energy & Environment, 8(4), pp. 1117-1127.
Zaromb, S., 1962. The use and behavior of aluminum anodes in alkaline primary batteries. Journal of The Electrochemical Society, 109(12), pp. 1125-1130.

### FIELD OF INVENTION

The present invention generally relates to electricity generation, and more particularly to a method and apparatus for the conversion of the chemical energy stored in aluminum into electricity using metal-air electrochemical fuel cells.

### PRIOR ART

Fuel cells using metal-air have historically served as the robust building blocks for generators developed to meet practical applications. A metal-air fuel cell is fundamentally a primary battery. While the anode is a metal (e.g., aluminum, zinc, iron, magnesium, lithium, calcium, sodium, potassium, tin, and germanium), the cathode is oxygen drawn directly from ambient air. The result is a high energy density appliance because of the much-reduced weight of the cells.

Aluminum-air batteries were originally proposed by (Zaromb, 1962), and (Bockstie, et al., 1963). Developments in aluminum-air batteries were reviewed by (Mori, 2020) who provided background information on the advantages and disadvantages of several types of metal-air fuel cells and compared them with aluminum-air fuel cells. The strength of the high energy density of the aluminum-air fuel cell contrasts with the challenges in maintaining cathode stability and preventing performance-inhibiting water vapor ingress. While aqueous electrolytes provide excellent ionic conductivity and efficient aluminum dissolution, managing water loss and preventing dendrite formation have limited a broad adoption of aluminum-air fuel cells. (Wang, et al., 2023) tackled the issue of continuous aluminum corrosion during battery standby by using an ethanol gel electrolyte in an aluminum-air battery. Potassium hydroxide is the solute and polyethylene oxide is the gelling agent.

Patents which taught different implementations of the aluminum-air fuel cell include:
(Niksa, et al., 1990) which describes an aqueous electrolyte aluminum-air battery with a consumable aluminum anode and an air cathode. The battery has a hydrophobic membrane that prevents the electrolyte from leaking out and allows hydrogen to escape. The battery is mechanically rechargeable by replacing the anode and/or the electrolyte.
(Miller, et al., 2021) which discloses aluminum-air battery units and stacks with frames that provide robust structural support and hermetic sealing for the anode and the cathode. The frame has a protective strap that protects the edges of the anode from corrosion and a trapezoidal shape that presses the strap against the anode. The anode can be replaced after electrolyte evacuation while maintaining the stack sealed.
(Sasaki, 2015) which proposes an aluminum-air battery and accumulator system that uses an electrolyte comprising a mixture of water and an ionic liquid. The system has a device for circulating the electrolyte between the battery and the accumulator, and a device for controlling the temperature and the pH of the electrolyte. The system can improve the performance and the lifetime of the battery.
(Friesen & Martinez, 2018) which relates to aluminum-based metal-air batteries that use an anode comprising an aluminum alloy and a cathode comprising a bifunctional catalyst. The batteries can have high energy density, high power density, and long cycle life. The batteries can also be recharged by electrochemical or mechanical methods.
(Friesen, et al., 2016) describes an aluminum-air cell using an organic solvent electrolyte that forms a protective layer on the aluminum anode during non-use, enabling efficient oxidation during discharge.

### BACKGROUND OF THE INVENTION

An aluminum-air fuel-cell is an electrochemical apparatus with cathode consisting of oxygen extracted from the air, an alkaline electrolyte, and aluminum as the anode and the fuel. Aluminum-air fuel cells hold immense potential as a sustainable energy solution. Aluminum is a readily available and inexpensive resource, making an aluminum-air fuel cell a cost-effective energy solution. The major challenge facing the widespread adoption of aluminum-air electrochemistry for practical electricity generation is the anodic aluminum self-corrosion. The electricity production of the fuel cell is severely inhibited by the reaction of the aluminum with water/oxygen in the electrolyte resulting in the production of hydrogen gas. The electrochemical reactions in an aluminum-air fuel cell, with an alkaline electrolyte, is described by (Mori, 2020):
Anode: Al→Al³⁺+3e⁻
Cathode: O₂+2H₂O+4e⁻→4OH⁻
Overall: 4Al+3O₂+6H₂O→4Al(OH)₃

Hydroxide ions are transported from the cathode to the anode through the medium of the electrolyte. The electricity production capacity, as well as the safety and stability of the fuel cell, is strongly dependent on the nature of the electrolyte.

The typical aluminum-air fuel-cell normally converts a small fraction of the 8.1 kWh of chemical energy inherent in every kilogram of anodic aluminum into electricity. This invention teaches the use of dual electrolytes, and a thin anodic aluminum wire, to produce an energy efficient fuel cell. In the anodic chamber is an anolyte consisting of a bioplastic electrolyte derived from a compound solution of sodium hydroxide or potassium hydroxide (KOH) and an organic binder. The cathodic chamber, which is separated from the anodic chamber by a low-cost membrane separator, uses vinegar as catholyte. The use of the bioplastic anolyte significantly reduces self-corrosion, limits parasitic gas production, and improves the performance of the aluminum-air fuel cell. Optimizing energy production per unit weight of anodic aluminum results in efficient ultra-low-cost electricity generators built using the aluminum-air fuel cell taught in this invention.

### SUMMARY OF THE INVENTION

According to the present invention there is provided a method of generating electricity form an electrochemical cell comprising a tubular anodic inner chamber mesh, a thin anodic aluminum wire, a bioplastic anolyte, a membrane separator, a carbonized cellulosic air-cathode doused in a catholyte, and an exterior mesh enclosure.

An advantage of the present invention is the provision of a method and apparatus for converting the intrinsic chemical energy of aluminum into electricity.

Another advantage of the present invention is the provision of a method and apparatus for electricity generation which provides maximal conversion of the chemical energy in aluminum into electricity.

Still another advantage of the present invention is the provision of a method and apparatus for electricity generation which utilizes a bioplastic electrolyte which enhances the electrochemical reactions by suppressing anodic corrosion and the evolution of hydrogen.

Still another advantage of the present invention is the provision of a method and apparatus for electricity generation which utilizes a thin aluminum wire as the solid fuel.

Still another advantage of the present invention is the provision of a method and apparatus for electricity generation which utilizes a solid fuel completely consumed, at the end of the electrochemical process, without the necessity for complicated spent-fuel evacuation.

Still another advantage of the present invention is the provision of a method and apparatus for electricity generation which utilizes a low-cost cellulosic membrane separator.

Still another advantage of the present invention is the formation of the entirety of the tubular fuel cell by spiral wrapping the composite material consisting of layered fiberglass, outer carbonized cellulosic material, conductive metal current collector, inner carbonized cellulosic material, membrane separator, and fiberglass.

Still other advantages of the invention will become apparent to those skilled in the art upon reading and understanding the following detailed description, accompanying drawings and appended claims.

### BRIEF DESCRIPTION OF DRAWINGS

The invention may take physical form in certain parts and arrangements of parts, a preferred embodiment and method of which will be described in detail in this specification and illustrated in the accompanying drawings which form a part hereof, and wherein:

FIG. 1 is an illustration of the isometric view of the Fuel Cell;

FIG. 2 is an illustration of the horizontal cross-section of the Fuel Cell;

FIG. 3 is an illustration of the vertical cross-section of the Fuel Cell;

FIG. 3A is an illustration of the steps involved in the Fuel Cell construction using the concentric dry wrapping method;

FIG. 3B is an illustration of the steps involved in the Fuel Cell construction using the concentric wet wrapping method;

FIG. 3C is an illustration of the steps involved in the Fuel Cell construction using the spiral dry wrapping method;

FIG. 4 is an illustration of the horizontal cross-sectional view of the arrangement of the Fuel Cells to form the Blade Module;

FIG. 5 is an illustration of the vertical cross-sectional view of the linear arrangement of the Fuel Cells to form the Blade Module;

FIG. 6 is an illustration of the horizontal cross-sectional view of the circles-in-circle arrangement of the Fuel Cells to form a 7-cell Cylindrical Module;

FIG. 7 is an illustration of the horizontal cross-sectional view of the circles-in-circle arrangement of the Fuel Cells to form a 19-cell Cylindrical Module;

FIG. 8 is an illustration of the horizontal cross-sectional view of the circles-in-circle arrangement of the Fuel Cells to form a 37-cell Cylindrical Module;

FIG. 9 is an illustration of the horizontal cross-sectional view of the circles-in-circle arrangement of the Fuel Cells to form a 61-cell Cylindrical Module;

FIG. 10 is an illustration of the isometric view of the linear arrangement of the Fuel Cells to form the Electricity Generator;

FIG. 11 is an illustration of the horizontal cross-sectional view Cylindrical Modules arranged to form the Electricity Generator;

FIG. 12 is an illustration of the isometric view of Cylindrical Modules arranged to form the Electricity Generator.

FIG. 13 is an illustration of the isometric view of Cylindrical Modules arranged Circles-in-Circles to form the Electricity Generator.

### DETAILED DESCRIPTION OF THE INVENTION

It should be appreciated that while a preferred embodiment of the present invention will be described with reference to aluminum-air fuel cell, other metal-air electrochemical cells are also suitable for use in connection with the present invention, such as zinc-air, iron-air, magnesium-air, lithium-air, calcium-air, sodium-air, potassium-air, tin-air, and germanium-air fuel cells.

In accordance with a preferred embodiment, the present invention teaches the generation of electricity using an electrochemical cell comprising: a) an inner chamber made of a mesh tube; b) an anode consisting of a thin aluminum wire; c) a bioplastic anolyte made from a compound solution of sodium hydroxide (NAOH) or potassium hydroxide (KOH), and a binder derived from Manihot Esculenta (known as Cassava); d) a vinegar-based catholyte; e) an air-cathode medium made from a carbonized porous cellulosic material; f) a membrane separator; and g) an exterior mesh enclosure.

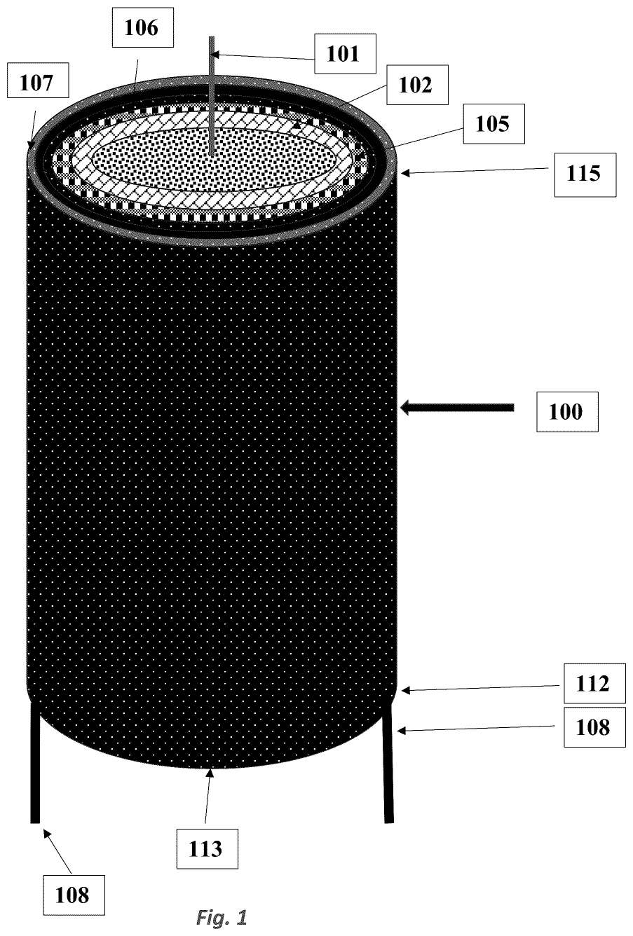

Referring now to the drawings wherein the showings are for the purposes of illustrating a preferred embodiment of the invention only and not for purposes of limiting same, FIG. 1 is an illustration of the isometric view of fuel cell 100. At the upper end of the tube, the aluminum anode 101, the fuel for the electricity generation, is dipped into the anodic chamber 102 through a pinhole 103 at the axial center of fuel cell 100. The top end of the anodic aluminum 101 jots out of the anodic chamber 102 to serve as the negative terminal of the electrochemical cell. Bioplastic anolyte 104 occupies the entirety of anodic chamber 102. According to the embodiment of this invention, the bioplastic anolyte 104 is injected into the anodic chamber 102.

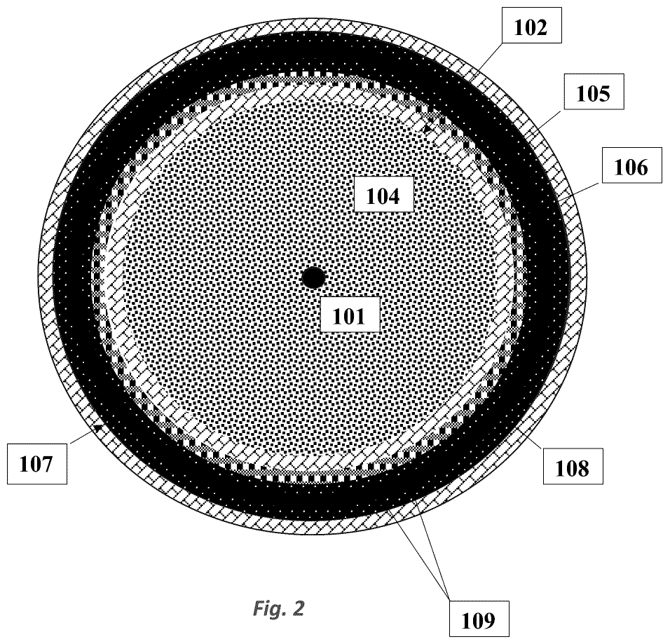

Referring now to FIG. 2:
1. BIOPLASTIC ANOLYTE 104. According to this invention, the anolyte is formulated by mixing x parts by volume of powdery NAOH or KOH with y parts by volume of Manihot Esculenta (known as Cassava), with z parts by volume of H₂O. The mixture is mechanically stirred until a uniformly smooth compound is achieved. The compound mixture ratios (x:y:z→1:1:2) has been found to be optimal for several applications.
   a. Hot Anolyte Injection. At the onset of the mixing, the anolyte immediately attains a high elevated temperature and remarkable fluidity. Injection of the hot fluid into the anodic chamber must be performed instantly ahead of the solidification which begins within minutes. The solidification process continues after the injection into the anodic chamber. When completed, the solid bioplastic anolyte fills up the entirety of the anodic chamber.
   b. Cold Anolyte Injection. In this approach, the anolyte is allowed to cool down and complete the solidification inside the mixing container. Thereafter, the bioplastic anolyte is injected into the anodic chamber using a caulking gun, or piecemeal by successfully pressing small tubular extracts into the chamber.
2. ANODIC CHAMBER 102. According to this invention, anodic chamber 102 can consist of:
   a. Rigid Mesh Plastic Tube. This is typically a perforated plastic tube of specific diameter and thickness. The degree of the tubular perforations determines the percentage of the circumferential area (Open Area) available for effective ionic transport through membrane separator 105.
   b. Fiberglass Mesh Tube. According to the preferred embodiment of this invention, the fiberglass mesh tube of desired diameter, length, and structural strength is achieved by folding a rectangular fiberglass sheet into a cylindrical shape of the specified dimensions. Another approach is to spiral wrap fiberglass tape around a cylindrical scaffold to attain the specified tubular dimensions. In all cases, glue is applied over the open wrapping edges to secure the tubular shape.
3. MEMBRANE SEPARATOR 105. The preferred membrane separator, according to this invention, is a cellulosic sheet (such as paper towel, cotton sheet, or bamboo fiber sheet) doused with Polyvinyl Acetate (PVA), a vinyl polymer. The thickness of membrane separator 105 ranges from 0.095 mm to 0.12 mm. The drenched sheet is utilized while wet for Methods 201 & 203 and air-dried for Method 202.
4. ALUMINUM ANODE 101. According to the preferred embodiment of this patent, the anode is pure aluminum or an alloy of aluminum in the form of a thin wire of diameter not exceeding 3 mm (Gauge 9). Aluminum with 90% or more purity drawn into a wire of diameter 1 mm (Gauge 18) provides the best performance in all the tests conducted.
5. AIR-CATHODE 106. The air-cathode is a composite material constituted by the current collector 108 sandwiched between two carbonized cellulosic sheets 109. Preferred materials for the current collector include:
   a. Pure Copper Woven Wire (40 Mesh) with 0.13 mm wire diameter
   b. Pure Copper Sheet of thickness 0.01 mm to 0.1 mm.
   c. Dual Conductive Copper Foil-0.08 mm thickness
   d. Stainless Steel—304 Woven Wire (400 Mesh)—0.03 mm wire diameter
   e. Stainless Steel—304 Woven Wire (200 Mesh)—0.06 mm wire diameter
   f. Stainless Steel—304 Woven Wire (120 Mesh)—0.08 mm wire diameter
6. EXTERIOR CONTAINER 107. The exterior container, according to this invention, can consist of:
   a. Rigid Plastic Mesh Tube 110—thickness 1.6 mm to 2.5 mm; open area 37% to 48%.
   b. Fiberglass Mesh Tube 111—(13 Mesh)-thickness 0.3 mm

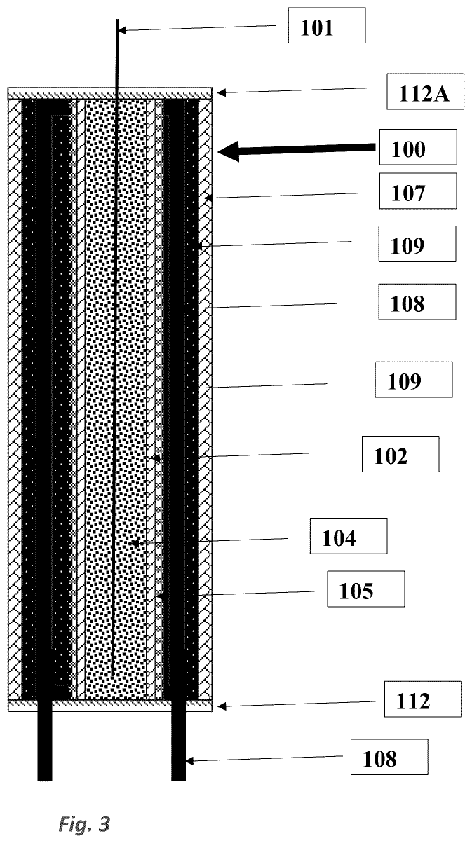

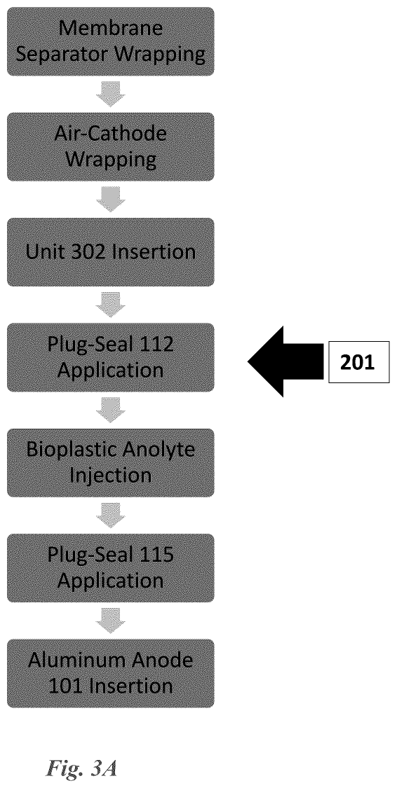

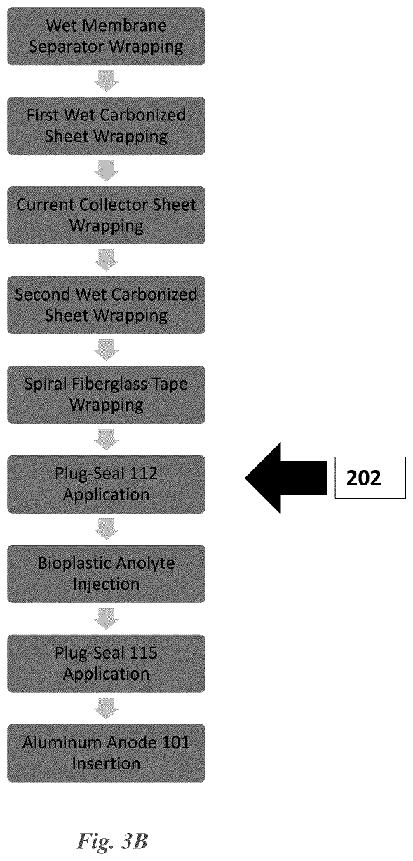

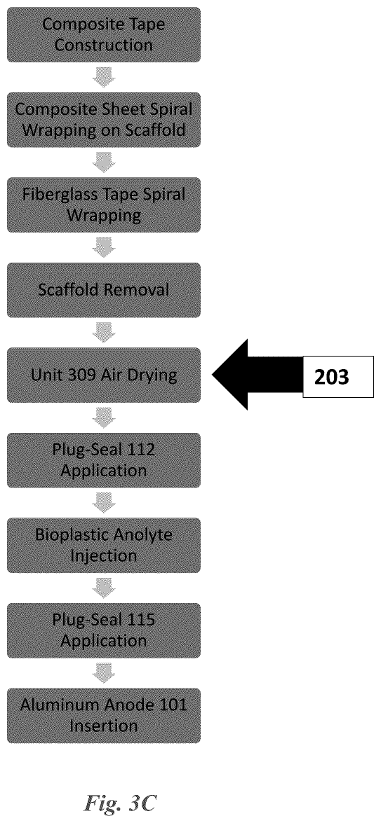

FIG. 3 is an illustration of the vertical cross-section of the Fuel Cell;

### Cell Construction

In the following presentation:
l=height of the fuel cell
d=diameter of the fuel cell
w=width of each wrapping component (such as the membrane separator sheet, carbonized cellulosic sheet, current collector sheet)
   1. CONCENTRIC DRY WRAPPING METHOD 201: The steps, as illustrated in FIG. 3A, are:
      a. Wrap membrane separator 105 around anodic chamber 102 to form Unit 301.
      b. Wrap air-cathode 106 around membrane separator 105 to form Unit 302.
      c. Insert Unit 302 into exterior container 107 to form Unit 303.
      d. Apply Plug-Seal 112 to positive terminal end 113.
      e. Inject bioplastic anolyte 104 through the negative terminal end 114.
      f. Apply Plug-Seal 112A to negative end 115.
      g. Insert aluminum anode 101 through pinhole 103 in Plug-Seal 112A.
   2. CONCENTRIC WET WRAPPING METHOD 202. The steps, as illustrated in FIG. 3B, are:
      a. Wrap wet freshly made membrane separator 105 around anodic chamber 102 to form Unit 304.
      b. Wrap wet the inner freshly carbonized sheet 109 around Unit 304 to form Unit 305.
      c. Wrap current collector sheet 108 around Unit 305 to form Unit 306.
      d. Wrap the outer freshly carbonized sheet 109 around Unit 306 to form Unit 307.
      e. Spiral wrap fiberglass tape 111A around Unit 307 to obtain exterior container 107 and Unit 308. Air dry Unit 308.
      f. Apply Plug-Seal 112 to positive terminal end 113.
      g. Inject bioplastic anolyte 104 through the negative terminal end 114.
      h. Apply Plug-Seal 112A to negative end 115.
      i. Insert aluminum anode 101 through pinhole 103 in Plug-Seal 112A.
   3. SPIRAL DRY WRAPPING METHOD 203: The steps, as illustrated in FIG. 3C, are:
      a. Construct composite tape, rectangular l×w strip, consisting of wet sequential layers of:
         Carbonized sheet 109, l×w.
         Current collector sheet 108, (l+l_{c})×w, where l_{c} is the tongue of the current collector.
         Carbonized sheet 109, l×w
         Membrane separator 105, l×w
         Fiberglass tape 111A, l×w
         Spiral wrap the composite sheet around a scaffold 116 (consisting of a plastic or glass tube or rod) to form Unit 309.
         Spiral wrap fiberglass tape 111A, l×w, around Unit 309 to obtain exterior container 107 and Unit 310.
         Remove scaffold 116.
         Air dry Unit 309.
      b. Apply Plug-Seal 112 to positive terminal end 113.
      c. Inject bioplastic anolyte 104 through the negative terminal end 114.
      d. Apply Plug-Seal 112A to negative end 115.
      e. Insert aluminum anode 101 through pinhole 103 in Plug-Seal 112A.

### Module Construction

In the following presentation, the single fuel cell is characterized by:
A_{c}=discharge current (Amps)·
V_{c}=average operating voltage (Volts)·
H_{c}=current capacity (Amp Hours
E_{c}=energy capacity (Watt Hours)
1. BLADE MODULE 401—SINGLE-LINE CELL ARRANGEMENT. The fuel cells are lined side-by-side in a single line. Connection Bus Bars 118 and 119 line the top and bottom of Blade Module 401. The cell ensemble is secured by shrink wrapping fiberglass sheet around the unit.
2. CYLINDRICAL MODULE 402—CIRCLES-IN-CIRCLE CELL ARRANGEMENT
If the N cells in a Module are connected in parallel, the Module will be characterized by:
   Module Discharge Current, A_{M}=N A_{c}
   Module Average Operating Voltage, V_{M}=V_{c}.
   Module Current Capacity, H_{M}=N H_{c}
   Module Energy Capacity, E_{M}=N E_{c}
If the N cells are connected in series, the Module will be characterized by:
   Module Discharge Current, A_{M}=A_{c}.
   Module Average Operating Voltage, V_{M}=N V_{c}
   Module Current Capacity, H_{M}=H_{c}
   Module Energy Capacity, E_{M}=N E_{c}

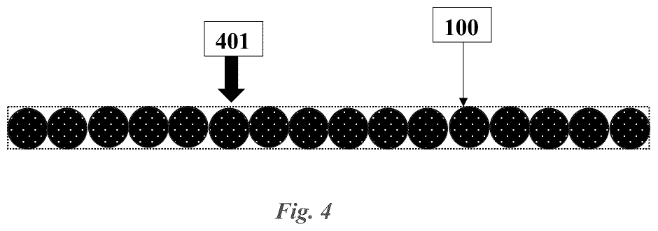

FIG. 4 is an illustration of the horizontal cross-sectional view of the arrangement of the fuel cells to form the Blade Module 401;

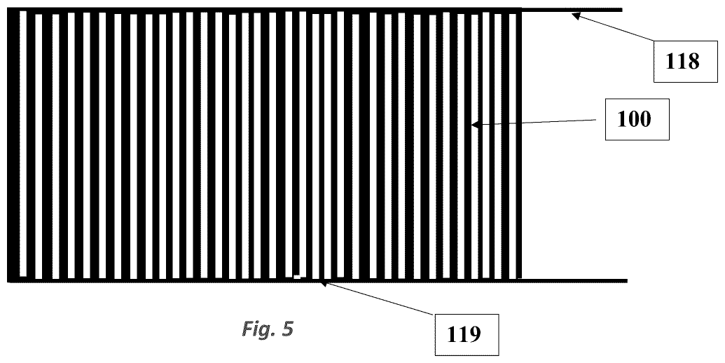

FIG. 5 is an illustration of the vertical cross-sectional view of the linear arrangement of the fuel cells to form the Blade Module 401;

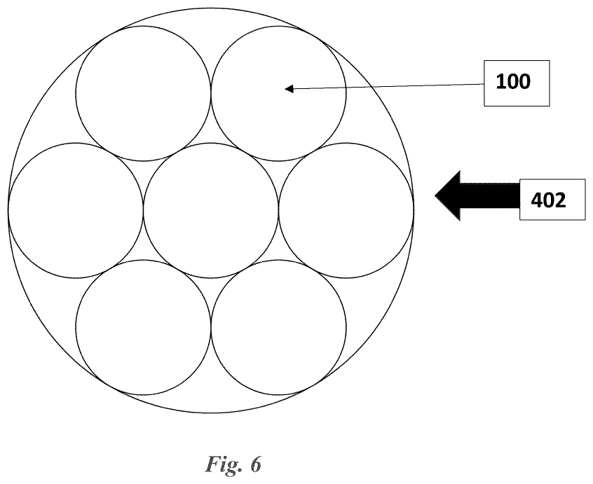

FIG. 6 is an illustration of the horizontal cross-sectional view of the circles-in-circle arrangement of the fuel cells to form a 7-cell Cylindrical Module 402;

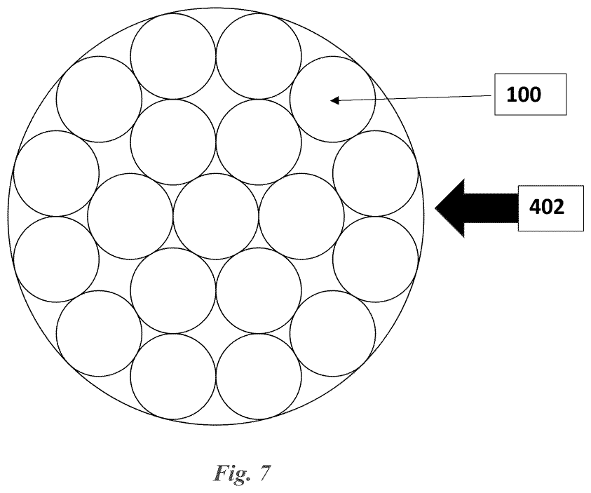

FIG. 7 is an illustration of the horizontal cross-sectional view of the circles-in-circle arrangement of the fuel cells to form a 19-cell Cylindrical Module 402;

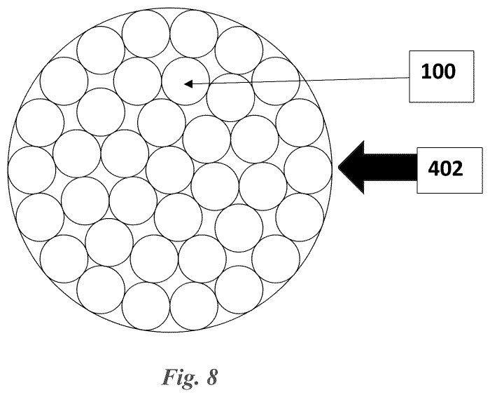

FIG. 8 is an illustration of the horizontal cross-sectional view of the circles-in-circle arrangement of the fuel cells to form a 37-cell Cylindrical Module 402;

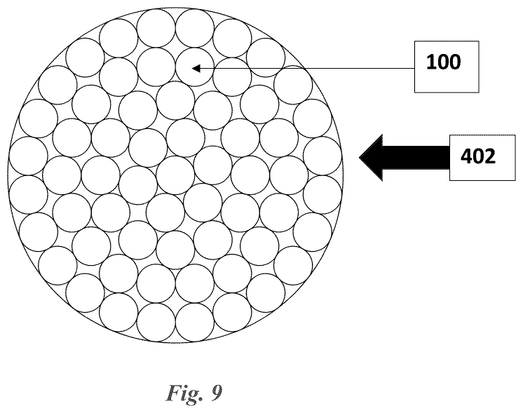

FIG. 9 is an illustration of the horizontal cross-sectional view of the circles-in-circle arrangement of the fuel cells to form a 61-cell Cylindrical Module 402;

### Electricity Generator Construction

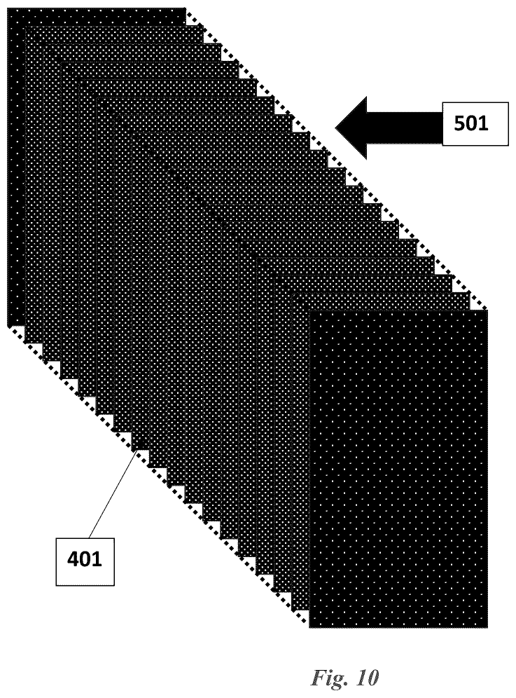

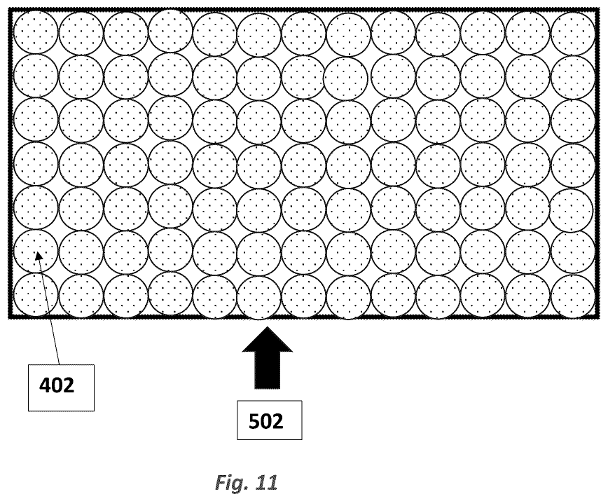

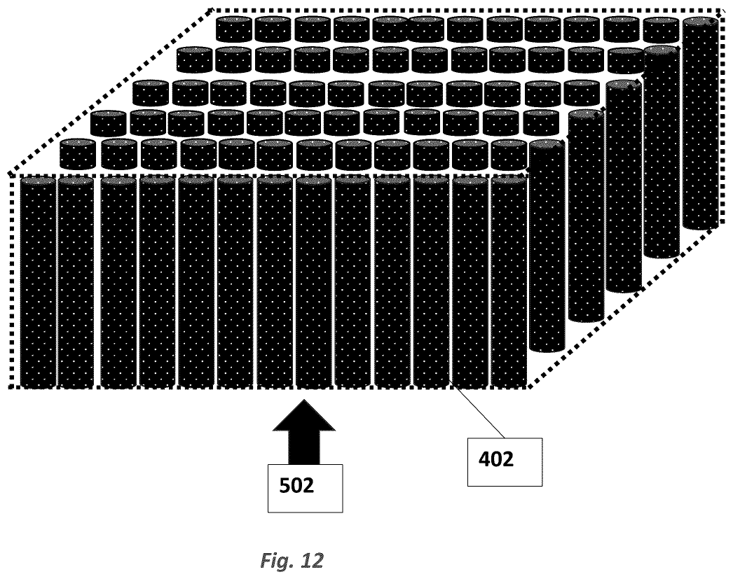

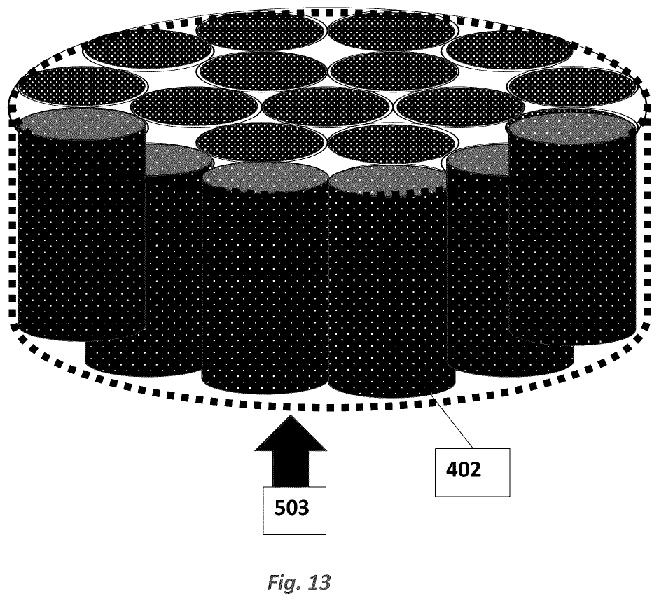

If the N_{P} Modules are connected in parallel, and N_{S} Modules are connected in series, the Generator will be characterized by:
Generator Discharge Current=N_{P} A_{M}
Generator Average Operating Voltage=N_{S} V_{M}
Generator Current Capacity=N_{P} H_{M}
Generator Energy Capacity=N_{P} N_{S} E_{M}
1. PRISMATIC GENERATOR: SIDE-BY-SIDE ARRANGEMENT OF BLADE MODULES 401 FIG. 10 is an illustration of the isometric view of Blade Modules 401 to form the Electricity Generator 501;
2. PRISMATIC GENERATOR: RECTANGULAR GRID ARRANGEMENT CYLINDRICAL MODULES 402
FIG. 11 is an illustration of the horizontal cross-sectional view Cylindrical Modules arranged to form the Electricity Generator 502;
FIG. 12 is an illustration of the isometric view of Cylindrical Modules arranged to form the Electricity Generator 502.
3. CYLINDRICAL GENERATOR: CIRCLES-IN-CIRCLE ARRANGEMENT OF CYLINDRICAL MODULES 402
FIG. 13 is an illustration of the isometric view of Cylindrical Modules arranged Circles-in-Circles to form the Electricity Generator 503.

### Examples

To establish the characteristics of the fuel cell, according to the invention disclosed herein, discharge tests were conducted on cells of distinct size configurations and construction approaches. In the following examples, the anolyte is from the mixture of 250 ml of sodium hydroxide, 250 ml of Manihot Esculenta (Cassava) starch, with 500 ml of H₂O. The catholyte is vinegar. The carbonized cellulosic material used for the air-cathode is a paper towel painted with carbon ink. The carbon ink is made from a mixture of activated carbon powder and manganese dioxide in a 2:1 (by weight) ratio.

### 2×25150 Fuel Cells

Diameter: 25 mm
Length: 150 mm
Anode: Aluminum wire-3 mm diameter (Gauge 9)
Current Collector: Dual conductive copper foil
Connection: 2 in series
Discharge current: 100 mA
Test duration: 3,321 minutes
Current Capacity: 5,536 mAh
Energy Produced: 9,695 mWh
Average Operating Voltage: 1.8V

### 12200 Fuel Cell

Diameter: 12 mm
Length: 200 mm
Anode: Aluminum wire-1 mm diameter (Gauge 18)
Current Collector: Woven Pure Copper 40 Mesh
Connection: single cell
Discharge current: 100 mA
Test duration: 2,644 minutes
Current Capacity: 4,434 mAh
Energy Produced: 3,563 mWh
Average Operating Voltage: 0.8V

### 501000 Fuel Cell

Diameter: 50 mm
Length: 1000 mm
Anode: Aluminum wire-3 mm diameter (Gauge 9)
Current Collector: Dual conductive copper foil
Connection: single cell
Discharge current: 100 mA
Test duration: 7,100 minutes
Current Capacity: 11,834 mAh
Energy Produced: 10,158 mWh
Average Operating Voltage: 0.9V

The present invention has been described with reference to a preferred embodiment. Obviously, modifications and alterations will occur to others upon a reading and understanding of this specification. It is intended that all such modifications and alterations be included insofar as they come within the scope of the appended claims or the equivalents thereof.

1. A method of generation of electricity using a dual-electrolyte electrochemical fuel cell comprising: an inner chamber made of a mesh tube; an anode consisting of a thin aluminum wire; a bioplastic anolyte made from a compound solution of sodium hydroxide (NAOH) or potassium hydroxide (KOH), and a binder derived from Manihot Esculenta (known as Cassava); vinegar-based catholyte; air-cathode medium made from a carbonized porous cellulosic material; a membrane separator; and exterior mesh enclosure.

2. A method according to claim 1, wherein the anolyte is a compound solution of sodium hydroxide (NAOH) or potassium hydroxide (KOH), and a binder derived from Manihot Esculenta (known as Cassava).

3. A method according to claim 1, wherein the air-cathode is a composite material made from a current collector sheet sandwiched by carbonized cellulosic materials.

4. A method according to claim 1, wherein the membrane separator is a cellulosic sheet doused with Polyvinyl Acetate (PVA).

5. A method according to claim 1, wherein the anode is a thin aluminum wire.

6. A method according to claim 2, wherein the freshly made bioplastic anolyte, in fluid state, is injected into the anodic chamber.

7. A method according to claim 2, wherein the solidified bioplastic anolyte is injected into the anodic chamber.

8. A method according to claim 1, wherein the fuel cell is built by concentric wrapping of dry components.

9. A method according to claim 1, wherein the fuel cell is built by concentric wrapping of wet components.

10. A method according to claim 1, wherein the fuel cell is built by spiral wrapping of composite layers of the components.

11. An apparatus according to claim 1, wherein the fuel cells are arranged in a sequential line and connected to form a Blade Module.

12. An apparatus according to claim 11, wherein the Blade Modules are arranged and connected to form a Prismatic Electricity Generator.

13. An apparatus according to claim 1, wherein the fuel cells are arranged in circles-in-circle formation and connected to form a Cylindrical Module.

14. An apparatus according to claim 13, wherein the Cylindrical Modules are arranged in rectangular grid formation and connected to form a Prismatic Electricity Generator.

15. An apparatus according to claim 13, wherein the Cylindrical Modules are arranged in circles-in-circle formation and connected to form a Cylindrical Electricity Generator.
